(19) United States
(12) Patent Application Publication
(10) Pub. No.: US 2024/0286931 A1
(43) Pub. Date: Aug. 29, 2024

(54) PERFLUOROALKYL COMPOUND-ADSORBING ACTIVATED CARBON

(71) Applicant: Futamura Kagaku Kabushiki Kaisha, Nagoya-shi, Aichi (JP)

(72) Inventors: Makoto YOKOI, Minokamo-shi, Gifu (JP); Shohei MIURA, Minokamo-shi, Gifu (JP)

(21) Appl. No.: 18/563,345

(22) PCT Filed: May 27, 2022
(86) PCT No.: PCT/JP2022/021742

§ 371 Date: Nov. 21, 2023

(30) Foreign Application Priority Data
Jun. 3, 2021 (JP) 2021-093623

(51) Int. Cl. C02F 1/28; C02F 101/36; G01N 30/02; G01N 30/72

(52) U.S. Cl. CPC C02F 1/283; G01N 30/02; G01N 30/7233; C02F 2101/36; G01N 2030/027

(57) ABSTRACT

A perfluoroalkyl compound-adsorbing activated carbon for adsorbing perfluoroalkyl compounds in water containing contaminants, wherein the activated carbon adsorbent has a pore volume sum of 0.025 cm³/g or less of pores having a pore diameter of 2 to 50 nm as measured by the DH plot method, and the activated carbon adsorbent has a pore volume sum of 0.014 cm³/g or more of pores having a pore diameter of 1.5 to 2 nm as measured by the MP plot method.

### FIELD

The present invention relates to a perfluoroalkyl compound-adsorbing activated carbon for adsorbing perfluoroalkyl compounds in water containing contaminants.

### BACKGROUND

Per- and polyfluoroalkyl compounds are fluorine-substituted aliphatic compounds having high thermal stability, high chemical stability, and high surface modification activity. Per- and polyfluoroalkyl compounds are widely used in industrial applications such as surface treatment agents, packaging materials, liquid fire-extinguishing agents, and chemical applications which take advantage of the characteristics described above.

Since some per- and polyfluoroalkyl compounds are highly stable chemical substances, they are not easily decomposed under natural conditions after being released into the environment. For this reason, in recent years, per- and polyfluoroalkyl compounds have been recognized as Persistent Organic Pollutants (POPs), and since 2010, the production and use of perfluorooctane sulfonic acid (PFOS) (IUPAC name: 1,1,2,2,3,3,4,4,5,5,6,6,7,7,8,8,8-heptadecafluorooctane-1-sulfonic acid) have been regulated under the Stockholm Convention on Persistent Organic Pollutants (POPs Convention).

In particular, perfluorooctane sulfonic acid (PFOS) and perfluorooctanoic acid (PFOA) are regulated worldwide, and in Japan, since Apr. 1, 2020, the standard value that the total value of perfluorooctane sulfonic acid (PFOS) and perfluorooctanoic acid (PFOA) is 50 ng/L or less has been added to the water quality management target setting items.

Perfluoroalkyl compounds including perfluorooctane sulfonic acid (PFOS) and perfluorooctanoic acid (PFOA) (IUPAC name: 2,2,3,3,4,4,5,5,6,6,7,7,8,8,8-pentadecafluorooctanoic acid) have a completely fluorinated linear alkyl group and are substances represented by chemical formula (i). Polyfluoroalkyl compounds are substances in which a portion of the hydrogen in an alkyl group is replaced with fluorine, and are represented by chemical formula (ii). Examples thereof include fluorotelomer alcohols.

$$\begin{matrix}[ Math 1 ] & \\ {C}_{n} {F}_{2 n + 1} - R & ( i )\end{matrix}$$

$$\begin{matrix}[ Math 2 ] & \\ {C}_{n} {F}_{2 n + 1} - {C}_{2} {H}_{4} - R & ( ii )\end{matrix}$$

In this manner, per- and polyfluoroalkyl compounds remain in the natural world (in water, soil, and the atmosphere), and thus, establishment of quantitative test methods for per- and polyfluoroalkyl compounds have been investigated. The challenge for studying quantitative test methods is the development of collection materials having high adsorption and desorption performance of per- and polyfluoroalkyl compounds. Water or air, as a sample containing a trace amount of per- and polyfluoroalkyl compounds, is brought into contact with a collection material to collect the per- and polyfluoroalkyl compounds, and the compounds adsorbed on the collection material are desorbed into an extraction liquid by an extraction step and concentrated. After concentration, quantitative measurement can be performed with a device such as an LC-MS/MS or GC-MS/MS to measure the concentration of per- and polyfluoroalkyl compounds contained in the sample.

The inventors have succeeded in developing per- and polyfluoroalkyl compound-adsorbing activated carbons as collection materials which can contribute to accurate quantitative measurement of per- and polyfluoroalkyl compounds (refer to Patent Literature 1 and 2). These adsorbing activated carbons satisfy certain physical properties, thereby enabling good adsorption and desorption of per- and polyfluoroalkyl compounds, which are the objects to be measured, thereby enabling accurate quantitative measurement of the compounds.

Next, regarding the removal of persistent organic fluorine compounds such as perfluoroalkyl compounds in so-called environmental water, it has been reported that due to the influence of contaminants such as organic matter contained in environmental water, residual organic fluorine compounds in environmental water cannot be sufficiently removed by water purification treatment using ozone or activated carbon treatment (refer to Non-Patent Literature 1).

### CITATION LIST

### Patent Literature

[PTL 1] Japanese Unexamined Patent Publication (Kokai) No. 2021-035671
[PTL 2] Japanese Unexamined Patent Publication (Kokai) No. 2021-079376

### Non-Patent Literature

[NPL 1] Koji Kimura et al., Research Center for Basin Environmental Quality, Graduate School of Engineering, Kyoto University, “Investigation of adsorption removal characteristics and influence factors of persistent organic fluorine compounds by powdered activated carbon” (Environmental Engineering Research Papers, Vol. 45, 2008, pp. 301-308)

### SUMMARY

### Technical Problem

In light of the above circumstances, the present invention provides a perfluoroalkyl compound-adsorbing activated carbon compound which is capable of efficiently adsorbing perfluoroalkyl compounds even in water containing contaminants such as, in particular, so-called environmental water and wastewater.

### Solution to Problem

Specifically, a first invention relates to a perfluoroalkyl compound-adsorbing activated carbon which is an activated carbon adsorbent for adsorbing a perfluoroalkyl compound in water containing contaminants, wherein a pore volume sum of pores having a pore diameter of 2 to 50 nm in the activated carbon adsorbent as measured by the DH plot method is 0.025 cm³/g or less, and a pore volume sum pores having a pore diameter of 1.5 to 2 nm in the activated carbon adsorbent as measured by the MP plot method is 0.014 cm³/g or more.

A second invention relates to the perfluoroalkyl compound-adsorbing activated carbon of the first invention, wherein the perfluoroalkyl compound is either or both of perfluorooctanesulfonic acid and perfluorooctanoic acid.

A third invention relates to the perfluoroalkyl compound-adsorbing activated carbon of the first or second invention, wherein the perfluoroalkyl compound-adsorbing activated carbon adsorbent has a tap specific gravity of 0.48 g/cc or more.

A fourth invention relates to the perfluoroalkyl compound-adsorbing activated carbon of any of the first to third inventions, wherein in the perfluoroalkyl compound-adsorbing activated carbon adsorbent, perfluoroalkyl compound adsorption performance per unit weight as measured by the following perfluoroalkyl compound adsorption performance evaluation test method is 600 μg/g or more for perfluorooctanesulfonic acid and 300 μg/g or more for perfluorooctanoic acid.

### [Perfluoroalkyl Compound Adsorption Performance Evaluation Test Method]

1. Test water is prepared by adding potassium hydrogen phthalate and humic acid to ultrapure water to obtain 3.1 mg/L (including humic acid 0.1 mg/L) of total organic carbon, and adding samples of perfluorooctanesulfonic acid and perfluorooctanoic acid thereto so as to achieve the respective concentrations of 500 ng/L (total concentration 1000 ng/L).

2. 0.1 mg of adsorbing activated carbon is added to 200 mL of the test water obtained in 1. above, which is shaken at 140 rpm for 48 hours using a constant temperature shaker at 25° C.

3. After shaking, the adsorbing activated carbon is removed by solid-liquid separation, and after extraction with a solvent containing methanol as the main component and concentration, and the concentrations of perfluorooctanesulfonic acid and perfluorooctanoic acid are measured by LC-MS/MS.

A fifth invention relates to the perfluoroalkyl compound-adsorbing activated carbon of any of the first to fourth inventions, wherein the perfluoroalkyl compound-adsorbing activated carbon is an adsorbent in a water filter of a water purifier.

### Advantageous Effects of Invention

Since the perfluoroalkyl compound-adsorbing activated carbon according to the first invention is an activated carbon adsorbent for adsorbing a perfluoroalkyl compound in water containing contaminants, wherein a pore volume sum of pores having a pore diameter of 2 to 50 nm in the activated carbon adsorbent as measured by the DH plot method is 0.025 cm³/g or less, and a pore volume sum of pores having a pore diameter of 0.014 cm³/g or more in the activated carbon adsorbent as measured by the MP plot method is 1.5 to 2 nm, a perfluoroalkyl compound even in water containing contaminants such as so-called environmental water and wastewater can be efficiently adsorbed.

According to the perfluoroalkyl compound-adsorbing activated carbon according to the second invention, since the perfluoroalkyl compound is either or both of perfluorooctanesulfonic acid and perfluorooctanoic acid, it can contribute to the removal of a regulated compound from water.

According to the perfluoroalkyl compound-adsorbing activated carbon according to the third invention, in the first or second invention, since the perfluoroalkyl compound-adsorbing activated carbon adsorbent has a tap specific gravity of 0.48 g/cc or more, the adsorption performance per unit volume is suitable, whereby the use thereof in existing facilities with a predetermined volume such as water purification plants can be expected. Furthermore, the use thereof for filter bodies such as existing water purifiers is possible, and handleability is excellent.

According to the perfluoroalkyl compound-adsorbing activated carbon according to the fourth invention, in any of the first to third inventions, since in the perfluoroalkyl compound-adsorbing activated carbon adsorbent, perfluoroalkyl compound adsorption performance per unit weight as measured by the following perfluoroalkyl compound adsorption performance evaluation test method is 600 μg/g or more for perfluorooctanesulfonic acid and 300 μg/g or more for perfluorooctanoic acid, even for water containing contaminants, good per- and polyfluoroalkyl compound adsorption performance is exhibited and the compounds can be efficiently removed.

According to the perfluoroalkyl compound-adsorbing activated carbon according to the fifth invention, in any of the first to fourth inventions, since the perfluoroalkyl compound-adsorbing activated carbon is an adsorbent in a water filter of a water purifier, the effect of selectively adsorbing perfluoroalkyl compounds is high even in water containing contaminants and the use as an adsorbent for water purification plants and water filters is suitable.

### DESCRIPTION OF EMBODIMENTS

The perfluoroalkyl compound-adsorbing activated carbon of the present invention comprises a fibrous activated carbon or a granular activated carbon. Fibrous activated carbon is an activated carbon obtained by carbonizing and activating appropriate fibers, and is, for example, phenol resin-based, acrylic resin-based, cellulose-based, or coal pitch-based. The fiber length, cross-sectional diameter, etc., are appropriate.

Examples of the raw material for granular activated carbon include wood (waste wood, thinned wood, sawdust), coffee grounds, rice husks, coconut husks, tree bark, and fruit. Carbonization and activation of these naturally-derived raw materials facilitate the development of pores. Furthermore, these raw materials can be procured inexpensively because they are a secondary use of waste. Baked products derived from synthetic resins such as tires, petroleum pitch, urethane resins and phenol resins, and coal can also be used as raw materials.

The activated carbon raw material is heated and carbonized in the temperature range of 200° C. to 600° C. as necessary to form micropores. Subsequently; the activated carbon raw material is exposed to steam and carbon dioxide in a temperature range of 600° C. to 1200° C. for activation treatment. As a result, activated carbon having various pores is produced. Zinc chloride activation and the like are also used for the activation. Sequential washing is also performed.

The physical properties of the activated carbon produced in this manner regulate the performance in adsorbing the target adsorbate. The adsorption performance of the activated carbon in adsorbing a perfluoroalkyl compound as the adsorbate of the invention of the present application is regulated by the pore size and volume of pores formed in the activated carbon. In particular, the adsorption performance is regulated by a pore volume of pores having a pore diameter of 2 to 50 nm (hereinafter referred to as “mesopores”) and a pore volume of pores having a pore diameter of 1.5 to 2 nm (hereinafter referred to as “micropores”).

The activated carbon of the present application adsorbs a perfluoroalkyl compound in water samples containing contaminants, so-called environmental water and industrial or domestic wastewater. In other words, the activated carbon is superior in perfluoroalkyl compound adsorption performance in water samples containing contaminants or impurities, not in purified water such as pure water free of impurities.

Contaminants contained in environmental water or wastewater include organic substances and metal ions. Organic substances include, for example, volatile organic substances, fulvic acid, and humic acid. The term “contaminants” as used therein refers to those dissolved in a water sample. Among these contaminants, large-molecule organic substances are adsorbed by the mesopores of the activated carbon, which prevents the target adsorbate from reaching the micropores. For this reason, if too many mesopores are developed, contaminants are adsorbed and thus clog the micropores for adsorbing perfluoroalkyl compounds, and there is a risk that the target adsorbate cannot be adsorbed.

The perfluoroalkyl compound adsorption efficiency is improved by developing micropores, which adsorb the target adsorbate, at or above a certain level. Since almost no metal ions are adsorbed by activated carbon, it is not considered that the adsorption of the target adsorbate is affected thereby.

The perfluoroalkyl compound-adsorbing activated carbon of the present application is configured so that a pore volume sum of pores having a pore diameter of 2 to 50 nm is 0.025 cm³/g or less, and a pore volume sum of 0.014 cm³/g or more of pores having a pore diameter is 1.5 to 2 nm, allowing for good adsorption of the target adsorbate while preventing adsorption of contaminants, which are a factor for clogging pores and thereby inhibiting the adsorption of the adsorbate.

As derived from the Examples, which are described later, when the pore volume sum of pores having a pore diameter of 2 to 50 nm in the perfluoroalkyl compound-adsorbing activated carbon is 0.025 cm³/g or less, the decrease in perfluoroalkyl compound adsorption performance of the activated carbon adsorbent can be suppressed even in water containing total organic carbon as the contaminants. The pore volume sum of pores having a pore diameter of 2 to 50 nm is measured by the DH plot method.

As is similarly derived from the Examples, which are described later, when the pore volume sum of pores having a pore diameter of 1.5 to 2 nm in the perfluoroalkyl compound-adsorbing activated carbon is 0.014 cm³/g or more, perfluoroalkyl compound adsorption performance of the activated carbon adsorbent is good. Since pores having a pore diameter of 1.5 to 2 nm are considered suitable for adsorbing perfluoroalkyl compounds, the development of pores having a pore diameter of 1.5 to 2 nm at or above a certain level is considered to contribute to good adsorption performance. The pore volume sum of pores having a pore diameter of 1.5 to 2 nm is measured by the MP plot method.

By using an activated carbon which satisfies the above physical properties, the perfluoroalkyl compound-adsorbing activated carbon of the present application can exhibit good adsorption performance for per- and polyfluoroalkyl compounds in water containing contaminants.

Furthermore, it is preferable that the tap specific gravity of the perfluoroalkyl compound-adsorbing activated carbon adsorbent be 0.48 g/cc or more. By using an activated carbon having a high tap specific gravity; the adsorption amount of perfluoroalkyl compounds per unit volume is improved, which is suitable as an adsorbent in a facility having a predetermined volume such as a water purification plant. When the adsorbing activated carbon is used in the filter body of a water purifier, it is possible to prevent the volume of the filter body from increasing, improve handleability, and it becomes possible to adsorb and remove perfluoroalkyl compounds with existing equipment.

In the perfluoroalkyl compound-adsorbing activated carbon adsorbent, when perfluoroalkyl compound adsorption performance per unit weight as measured by the perfluoroalkyl compound adsorption performance evaluation test method is 600 μg/g or more for perfluorooctanesulfonic acid and 300 μg/g or more for perfluorooctanoic acid, the adsorption performance is suitable, and perfluoroalkyl compounds in water containing contaminants can be effectively adsorbed and removed.

Test water is prepared by adding potassium hydrogen phthalate and humic acid to ultrapure water to obtain 3.1 mg/L (including humic acid 0.1 mg/L) of total organic carbon, and adding samples of perfluorooctanesulfonic acid and perfluorooctanoic acid thereto so as to achieve the respective concentrations of 500 ng/L (total concentration 1000 ng/L). Adding two organic substances, potassium hydrogen phthalate and humic acid, is for the purpose of performing an adsorption performance evaluation test of perfluoroalkyl compounds by simulating a state in which a plurality of organic substances, i.e., contaminants having different molecular sizes, are dissolved in water in the manner of so-called environmental water.

0.1 mg of adsorbing activated carbon is added to 200 mL of the test water and shaken at 140 rpm for 48 hours using a constant temperature shaker at 25° C., the adsorbing activated carbon is removed by solid-liquid separation, and after extraction with a solvent containing methanol as the main component and concentration, the concentrations of perfluorooctanesulfonic acid and perfluorooctanoic acid are measured by LC-MS/MS.

### EXAMPLES

### [Activated Carbon Adsorbent Used]

The inventors used the following activated carbons to evaluate the perfluoroalkyl compound adsorption performance in water containing contaminants.

### Preparation Example 1

Coconut shell activated carbon “CT”: produced by Futamura Chemical Co., Ltd.

### Preparation Example 2

Coconut shell activated carbon “CN”: produced by Futamura Chemical Co., Ltd.

### Preparation Example 3

Coconut shell activated carbon “CW-L”: produced by Futamura Chemical Co., Ltd.

### Preparation Example 4

Coconut shell activated carbon “CW-S”: produced by Futamura Chemical Co., Ltd.

### Preparation Example 5

Coconut shell activated carbon “CW-R”: produced by Futamura Chemical Co., Ltd.

### Preparation Example 6

Coconut shell activated carbon “CW-Z”: produced by Futamura Chemical Co., Ltd.

### Preparation Example 7

Coal activated carbon “GL-A”: produced by Futamura Chemical Co., Ltd.

### Preparation Example 8

Wood activated carbon “S”: produced by Futamura Chemical Co., Ltd.

### Preparation Example 9

Fibrous activated carbon “FE3018” (average fiber diameter: 15 μm): produced by Futamura Chemical Co., Ltd.

### Preparation Example 10

Spherical activated carbon “MGP”: produced by Futamura Chemical Co., Ltd.

### [Measurement of Activated Carbon]

### [Specific Surface Area]

The specific surface area (m²/g) is determined by measuring the nitrogen adsorption isotherm at 77 K using an automatic specific surface area/pores distribution measuring device “BELSORP-mini II” manufactured by Microtrack Bell Co., Ltd., using the BET method (BET specific surface area).

### [Pore Volume]

The pore volume (cm³/g) is measured through nitrogen adsorption using an automatic specific surface area/pore distribution measuring device (“BELSORP-mini II”, manufactured by Microtrack Bell Co., Ltd.).

### [Average Pore Diameter]

The average pore diameter (nm) is determined from formula (iii) using the pore volume (cm³/g) and specific surface area (m²/g), assuming that the pore shape is cylindrical.

$$\begin{matrix}[ Math 3 ] & \\ Avg pore diameter ( nm ) = \frac{Pore volume ( {cm}^{3} / g )}{Specific surface area ( {m}^{2} / g )} \times 4 \times 1000 & ( iii )\end{matrix}$$

### [Pore Volume Sum of Micropores]

The pore volume sum (cm³/g) of micropores is measured through nitrogen adsorption using an automatic specific surface area/pores distribution measuring device (“BELSORP-mini II”, manufactured by Microtrack Bell Co., Ltd.) in the same manner as the above pore volume. The pore volume sum (cm³/g) of pores having a pore diameter of 1.5 to 2 nm is determined by analysis by the MP method from the t-plot of the nitrogen gas adsorption isotherm for the dV/dD value in the pore diameter range of 1.5 to 2 nm.

### [Pore Volume Sum of Mesopores]

The dV/dD value in the pore diameter range of 2 to 50 nm is analyzed by the DH method from the nitrogen gas adsorption isotherm. The range of pore diameters of 2 to 50 nm is 2.43 to 51.624 nm in the analysis software. From this analysis result, the pore volume sum (cm³/g) of mesopores, which is the pore volume of pores having a pore diameter ranging from 2 to 50 nm, is determined.

### [Surface Oxide Amount]

The surface oxide amount (meq/g) is measured by applying the Boehm's method, in which the adsorbing activated carbon of each example is shaken in a 0.05 N sodium hydroxide aqueous solution and filtered, and the filtrate is neutralized and titrated with 0.05 N hydrochloric acid to determine the amount of sodium hydroxide as the surface oxide amount.

### [Methylene Blue Adsorption Performance]

The methylene blue adsorption performance (mL/g) is measured in accordance with JIS K 1474 (2014).

[pH]

The pH is measured in accordance with JIS K 1474 (2014).

### [Tap Specific Gravity]

Tap specific gravity (g/cc) is determined by placing the adsorbing activated carbon of each preparation example into a 150 mL cylinder and measuring the weight. Next, the cylinder is set in a tapping machine (manufactured by Kuramochi Kagaku Kikai Seisakusho Co., Ltd.) and a shock is applied thereto for 2 hours. The specific gravity of the activated carbon is calculated from the scale and weight of the cylinder, and is taken as the tap specific gravity.

The physical properties of the activated carbons of Preparation Examples 1 to 10 are as shown in Tables 1 and 2. They are, from the top of the table, specific surface area (m²/g), pore volume (cm³/g), average pore diameter (nm), pore volume sum of micropores (cm³/g), pore volume sum of mesopores (cm³/g), surface oxide amount (meq/g), methylene blue adsorption performance (mL/g), pH, and tap specific gravity (g/cc).

TABLE 1

| | | Prep Ex 1 | Prep Ex 2 | Prep Ex 3 | Prep Ex 4 | Prep Ex 5 |
|---|---|---|---|---|---|---|
| Specific surface area | (m²/g) | 1051 | 982 | 983 | 1113 | 1281 |
| Pore volume | (cm³/g) | 0.51 | 0.43 | 0.44 | 0.59 | 0.66 |
| Avg pore diameter | (nm) | 1.93 | 1.76 | 1.77 | 1.75 | 2.05 |
| Micropore pore volume sum | (cm³/g) | 0.0242 | 0.0067 | 0.0233 | 0.0180 | 0.0145 |
| Mesopore pore volume sum | (cm³/g) | 0.0147 | 0.0075 | 0.0139 | 0.0122 | 0.0105 |
| Surface oxide amt | (meq/g) | 0.186 | 0.154 | 0.146 | 0.204 | 0.250 |
| Methylene blue | (mL/g) | 170 | 120 | 190 | 190 | 180 |
| adsorption performance | | | | | | |
| pH | | 6.8 | 6.7 | 6.8 | 6.7 | 6.5 |
| Tap specific gravity | (g/cc) | 0.670 | 0.698 | 0.670 | 0.650 | 0.530 |

TABLE 2

| | | Prep Ex | Prep Ex | Prep Ex | Prep Ex | Prep Ex |
|---|---|---|---|---|---|---|
| | | 6 | 7 | 8 | 9 | 10 |
| Specific surface area | (m²/g) | 1622 | 980 | 1636 | 1962 | 1969 |
| Pore volume | (cm³/g) | 0.90 | 0.55 | 1.68 | 0.90 | 1.04 |
| Avg pore diameter | (nm) | 2.23 | 2.24 | 4.10 | 1.83 | 2.10 |
| Micropore pore volume sum | (cm³/g) | 0.0554 | 0.0741 | 0.2440 | 0.0319 | 0.0525 |
| Mesopore pore volume sum | (cm³/g) | 0.0515 | 0.0514 | 0.2515 | 0.0241 | 0.0674 |
| Surface oxide amt | (meq/g) | 0.372 | 0.222 | 0.486 | 0.132 | 0.55 |
| Methylene blue adsorption | (mL/g) | 260 | 160 | 180 | 330 | 350 |
| performance | | | | | | |
| pH | | 7.1 | 6.7 | 5.5 | 6.8 | 6.5 |
| Tap specific gravity | (g/cc) | 0.420 | 0.650 | 0.304 | 0.489 | 0.403 |

### [Adsorption Experiment of Per- and Polyfluoroalkyl Compounds in Water Containing Contaminants]

At this time, PFOA (C₈HF₁₅O₂) and PFOS (C₈HF₁₇O₃S) were used as the perfluoroalkyl compounds, and the adsorption performance of the activated carbon of each Preparation Example was evaluated.

Potassium hydrogen phthalate (manufactured by Kanto Kagaku Co., Ltd.) and humic acid (manufactured by Fujifilm Wako Pure Chemical Co., Ltd.) were used to prepare test water adjusted to 3.1 mg/L of total organic carbon (including humic acid: 0.1 mg/L) and ultrapure water. Target PFOA and PFOS standard reagents were added to the test water and ultrapure water to prepare a test solution 1 (test water) and a test solution 2 (ultra-pure water) having concentrations of PFOA and PFOS of 500 ng/L each (total concentration of 1000 ng/L).

0.1 mg of activated carbon of each Preparation Example pulverized to an average particle size of 10±4 μm was added to a container containing 200 mL of the test solution 1 or 2 and shaken at 140 rpm for 48 hours using a constant temperature shaker (Manufactured by Tokyo Rikakikai Co., Ltd.) at 25° C. Thereafter, the activated carbon was removed by solid-liquid separation, and an extract was collected using a solvent containing methanol as a main component.

After concentrating the collected extract to 1 mL with a nitrogen blowing concentrator, the extract was quantitatively measured in MRM mode using LC-MS/MS (“LCMS-8030”, manufactured by Shimadzu Corporation) to measure the concentrations of PFOA and PFOS.

Tables 3 and 4 show the adsorption amount (μg/g) per unit weight and the adsorption amount (μg/cc) per unit volume (μg/cc) for each target substance for Preparation Examples 1 to 10 for each test solution. A PFOA adsorption amount per unit weight (μg/g) of 500 μg/g or more was evaluated as “Excellent”, 300 to 500 μg/g as “Good”, and less than 300 μg/g as “Poor”. A PFOA adsorption amount per unit volume (μg/cc) of 300 μg/cc or more was evaluated as “Excellent”, “Good” when it was 200 to 300 μg/cc, and “Poor” when it was less than 200 μg/cc. A PFOS adsorption amount (μg/g) per unit weight of 800 μg/g or more was evaluated as “Excellent”, 600 to 800 μg/g as “Good”, and less than 600 μg/g as “Poor”. The PFOS adsorption amount (μg/cc) per unit volume was evaluated as “Excellent” when it was 600 μg/cc or more, “Good” when it was 400 to 600 μg/cc, and “Poor” when it was less than 400 μg/cc. The adsorption ratio (%) of the adsorption amount in test solution 1 (test water) to the adsorption amount in test solution 2 (ultrapure water) is shown for each target substance.

TABLE 3

| | | Test solution 1 | | | | Test solution 2 | | | |
|---|---|---|---|---|---|---|---|---|---|
| | | PFOA | | PFOS | | PFOA | | PFOS | |
| | | (μg/g) | (μg/cc) | (μg/g) | (μg/cc) | (μg/g) | (μg/cc) | (μg/g) | (μg/cc) |
| Prep Ex 1 | Adsorption amt | 414.3 | 277.6 | 910.0 | 609.7 | 1264.3 | 847.1 | 1094.3 | 733.2 |
| | Eval | Good | Good | Excellent | Excellent | Excellent | Excellent | Excellent | Excellent |
| | Adsorption ratio | 32.8% | | 83.2% | | — | | — | |
| Prep Ex 2 | Adsorption amt | 257.1 | 179.5 | 328.6 | 229.3 | 1250.0 | 872.5 | 1100.0 | 767.8 |
| | Eval | Poor | Poor | Poor | Poor | Excellent | Excellent | Excellent | Excellent |
| | Adsorption ratio | 20.6% | | 29.9% | | — | | — | |
| Prep Ex 3 | Adsorption amt | 457.1 | 306.3 | 818.6 | 548.4 | 1271.4 | 851.9 | 1095.7 | 734.1 |
| | Eval | Good | Excellent | Excellent | Good | Excellent | Excellent | Excellent | Excellent |
| | Adsorption ratio | 36.0% | | 74.7% | | — | | — | |
| Prep Ex 4 | Adsorption amt | 528.6 | 343.6 | 980.0 | 637.0 | 1274.3 | 828.3 | 1101.4 | 715.9 |
| | Eval | Excellent | Excellent | Excellent | Excellent | Excellent | Excellent | Excellent | Excellent |
| | Adsorption ratio | 41.5% | | 89.0% | | — | | — | |
| Prep Ex 5 | Adsorption amt | 500.0 | 265.0 | 814.3 | 431.6 | 1250.0 | 662.5 | 1105.7 | 586.0 |
| | Eval | Excellent | Good | Excellent | Good | Excellent | Excellent | Excellent | Good |

| | | | | |
|---|---|---|---|---|
| Adsorption ratio | 40.0% | 73.6% | — | — |

TABLE 4

| | | Test solution 1 | | | | Test solution 2 | | | |
|---|---|---|---|---|---|---|---|---|---|
| | | PFOA | | PFOS | | PFOA | | PFOS | |
| | | (μg/g) | (μg/cc) | (μg/g) | (μg/cc) | (μg/g) | (μg/cc) | (μg/g) | (μg/cc) |
| Prep Ex 6 | Adsorption amt | 285.7 | 120.0 | 662.0 | 278.0 | 1264.3 | 531.0 | 1088.6 | 457.2 |
| | Eval | Poor | Poor | Good | Poor | Excellent | Excellent | Excellent | Good |
| | Adsorption ratio | 22.6% | | 60.8% | | — | | — | |
| Prep Ex 7 | Adsorption amt | 153.0 | 99.5 | 754.4 | 490.4 | 1250.0 | 812.5 | 1091.4 | 709.4 |
| | Eval | Poor | Poor | Good | Good | Excellent | Excellent | Excellent | Excellent |
| | Adsorption ratio | 12.2% | | 69.1% | | — | | — | |
| Prep Ex 8 | Adsorption amt | 108.6 | 33.0 | 600.0 | 182.4 | 714.3 | 217.1 | 1041.4 | 316.6 |
| | Eval | Poor | Poor | Good | Poor | Excellent | Good | Excellent | Poor |
| | Adsorption ratio | 15.2% | | 57.6% | | — | | — | |
| Prep Ex 9 | Adsorption amt | 442.9 | 216.6 | 875.7 | 428.2 | 1250.0 | 611.3 | 1095.3 | 535.6 |
| | Eval | Good | Good | Excellent | Good | Excellent | Excellent | Excellent | Good |
| | Adsorption ratio | 35.4% | | 80.0% | | — | | — | |
| Prep Ex 10 | Adsorption amt | 200.0 | 80.6 | 979.9 | 394.9 | 1260.3 | 507.9 | 1095.3 | 441.4 |
| | Eval | Poor | Poor | Excellent | Poor | Excellent | Excellent | Excellent | Good |

| | | | | |
|---|---|---|---|---|
| Adsorption ratio | 15.9% | 89.5% | — | — |

### [Results and Discussion]

In Preparation Examples 2, 6 to 8, 10, particularly, the PFOA adsorption amount was low in test solution 1, indicating insufficient target substance adsorption. The adsorption ratios of the test solution 1 containing contaminants relative to the adsorption amount of test solution 2 (ultrapure water) were 10 to 20% for PFOA and less than 70% for PFOS, with the exception of Preparation Example 10. This indicates that, in the presence of contaminants, the adsorption of the target substances in water was poor. In particular, in Preparation Example 2, the PFOS adsorption amount was also low:

Conversely, in Preparation Examples 1, 3 to 5, 9, the adsorption amounts of PFOA and PFOS in test solution 1 were both good, indicating that the adsorption of the target substances was sufficient. The adsorption ratios of the test solution 1 containing contaminants relative to the test solution 2 (ultrapure water) were 30% or more for PFOA and 70% or more for PFOS. Since Preparation Examples 1, 3 to 5, and 9 exhibited good adsorption performance in test solution 2, it was understood that good adsorption performance was exhibited even in water in the presence of contaminants.

From these results, it is considered that the adsorption of the target substances did not progress in Preparation Examples 6 to 8 and 10, which are activated carbons having many developed mesopores, because the pores of the activated carbon adsorbed contaminants and became clogged. For Preparation Example 2, it is considered that the micropores, which are believed to adsorb the target substances, were not sufficiently developed, and the mesopores for introducing the target substances into the micropores were not sufficiently developed, whereby the adsorption performance was not well exhibited in water in the presence of contaminants.

Preparation Examples 1, 3 to 5, and 9 were also excellent in the amount of target substances adsorbed per unit volume (μg/cc). Since the use of the activated carbon adsorbent of the present invention in, for example, water purification plants and water purification filters is considered to be more limited by the volume than the weight, the activated carbon adsorbent is considered to preferably have a tap specific gravity at or above a certain level.

### INDUSTRIAL APPLICABILITY

The perfluoroalkyl compound-adsorbing activated carbon of the present invention can efficiently adsorb perfluoroalkyl compounds in water containing contaminants, whereby regulated perfluoroalkyl compound can be effectively removed and contribution to the resolution of environmental problems can be expected.

1. A perfluoroalkyl compound-adsorbing activated carbon which is an activated carbon adsorbent for adsorbing a perfluoroalkyl compound in water containing contaminants, wherein
a pore volume sum of pores having a pore diameter of 2 to 50 nm in the activated carbon adsorbent as measured by the DH plot method is 0.025 cm³/g or less, and
a pore volume sum of pores having a pore diameter of 1.5 to 2 nm in the activated carbon adsorbent as measured by the MP plot method is 0.014 cm³/g or more.

2. The perfluoroalkyl compound-adsorbing activated carbon according to claim 1, wherein the perfluoroalkyl compound is either or both of perfluorooctanesulfonic acid and perfluorooctanoic acid.

3. The perfluoroalkyl compound-adsorbing activated carbon according to claim 1, wherein the perfluoroalkyl compound-adsorbing activated carbon adsorbent has a tap specific gravity of 0.48 g/cc or more.

4. The perfluoroalkyl compound-adsorbing activated carbon according to claim 1, wherein in the perfluoroalkyl compound-adsorbing activated carbon adsorbent, perfluoroalkyl compound adsorption performance per unit weight as measured by the following perfluoroalkyl compound adsorption performance evaluation test method is 600 μg/g or more for perfluorooctanesulfonic acid and 300 μg/g or more for perfluorooctanoic acid:
[Perfluoroalkyl compound adsorption performance evaluation test method]
1. test water is prepared by adding potassium hydrogen phthalate and humic acid to ultrapure water to obtain 3.1 mg/L (including humic acid 0.1 mg/L) of total organic carbon, and adding samples of perfluorooctanesulfonic acid and perfluorooctanoic acid thereto so as to achieve the respective concentrations of 500 ng/L (total concentration 1000 ng/L);
2. 0.1 mg of adsorbing activated carbon is added to 200 mL of the test water obtained in 1. above and shaken at 140 rpm for 48 hours using a constant temperature shaker at 25° C.;
3. after shaking, the adsorbing activated carbon is removed by solid-liquid separation, and after extraction with a solvent containing methanol as the main component and concentration, the concentrations of perfluorooctanesulfonic acid and perfluorooctanoic acid are measured by LC-MS/MS.

5. The perfluoroalkyl compound-adsorbing activated carbon according to claim 1, wherein the perfluoroalkyl compound-adsorbing activated carbon is an adsorbent in a water filter of a water purifier.
